(19) United States
(12) Patent Application Publication
(10) Pub. No.: US 2026/0112040 A1
(43) Pub. Date: Apr. 23, 2026

(54) SYSTEM AND METHOD FOR INITIATING SELECTIVE PRIVACY OVERRIDES FOR TARGETED OBJECT RECOGNITION

(71) Applicant: MOTOROLA SOLUTIONS, INC., Chicago, IL (US)

(72) Inventors: Piotr FURMAN, Grojec (PL); Piotr FISZER, Czestochowa (PL); Wojciech WOJCIK, Krakow (PL)

(21) Appl. No.: 18/921,752

(22) Filed: Oct. 21, 2024

(51) Int. Cl. G06T 7/20; G06V 20/40; G06V 40/16

(52) U.S. Cl. CPC G06T 7/20; G06V 20/44; G06V 40/161; G06V 40/172; G06T 2207/30241; G06V 2201/07

(57) ABSTRACT

An example method includes: obtaining video data captured from a video camera having a field of view; initiating a privacy override for the video data for a time duration, the privacy override applicable to time-dependent, spatial locations consistent with a tracking trajectory of a target object; applying object detection analytics to detect a plurality of objects in the field of view of the video camera; applying the privacy override to enable object recognition analytics to be applied to the video data over the time duration of the privacy override, at the locations of the privacy override, to selectively identify the target object from the plurality of objects and inhibiting the object recognition analytics for a remainder of the plurality of objects.

### BACKGROUND

Many video cameras are operated by public and private enterprises to monitor public and private spaces for security. The video data obtained can be analyzed and used to facilitate public safety monitoring.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a schematic diagram of an example system for initiating selective privacy overrides for targeted object recognition.

FIG. 2 is a block diagram of the server shown in FIG. 1.

FIG. 3 is a flowchart of an example method for initiating selective privacy overrides for targeted object recognition.

FIG. 4 is a flowchart of an example method of identifying an event for initiating a selective privacy override.

FIG. 5 is a schematic diagram of predicted tracking trajectories and time-dependent spatial locations consistent with the tracking trajectories.

FIG. 6 is a flowchart of an example method for extending privacy overrides based on tracking trajectories.

FIG. 7 is a schematic diagram of extending privacy overrides based on tracking trajectories.

FIGS. 8A and 8B are schematic diagrams of example fields of view with portions approved for selective privacy overrides.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

While video data may be widely available, both from public infrastructure and private sources, large scale video analytics, particularly on the large amount of available video data, can be computationally expensive and may additionally be harmful to the privacy rights of private citizens. In some cases, such performance of such video analytics to recognize and potentially track individuals may violate local regulations. From a public safety perspective, such video analytics may be helpful to identify and proactively track suspects of criminal activity or potential public safety risks.

Accordingly, as described herein, some limited video analytics may detect potential risk situations without violating privacy rights. When risk events are detected, a privacy override may be initiated to permit performance of privacy sensitive analytics, including facial recognition. Such analytics may be additionally limited based on particular field of view and camera parameters, as well as a tracking trajectory of the target suspect to balance privacy and public safety considerations, as well as to limit the amount of computationally expensive recognition analytics performed.

In accordance with one example embodiment, a method includes: obtaining video data captured from a video camera having a field of view; initiating a privacy override for the video data for a time duration, the privacy override applicable to time-dependent, spatial locations consistent with a tracking trajectory of a target object; applying object detection analytics to detect a plurality of objects in the field of view of the video camera; applying the privacy override to enable object recognition analytics to be applied to the video data over the time duration of the privacy override, at the locations of the privacy override, to selectively identify the target object from the plurality of objects and inhibiting the object recognition analytics for a remainder of the plurality of objects.

In accordance with another example embodiment, a computing device includes: computing device comprising: a memory storing executable code; a communications interface; a processor interconnected with the memory and the communications interface, the processor to execute the code, the code operable to cause the processor to: obtain video data captured from a video camera having a field of view; initiate a privacy override for the video data for a time duration, the privacy override applicable to time-dependent, spatial locations consistent with a tracking trajectory of a target object; apply object detection analytics to detect a plurality of objects in the field of view of the video camera; apply the privacy override to enable object recognition analytics to be applied to the video data over the time duration of the privacy override, at the locations of the privacy override, to selectively identify the target object from the plurality of objects and inhibit the object recognition analytics for a remainder of the plurality of objects.

Each of the above-mentioned embodiments will be discussed in more detail below, starting with example system and device architectures of the system in which the embodiments may be practiced, followed by an illustration of processing blocks for achieving an improved technical method, device, and system for initiating selective privacy overrides for targeted object recognition.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

The term “object detection” as used herein is understood to encompass in its meaning both object detection without object classification, and also object detection with object classification; however, consistent with its meaning as understood by those skilled in the art, “biometric recognition” is not object detection.

The term “biometric recognition” as used herein means object recognition involving biometrics such as, for example, facial recognition, human gait recognition and recognition based on unique physical identifiers (e.g. tattoos, scars and the like).

Further advantages and features consistent with this disclosure will be set forth in the following detailed description, with reference to the figures.

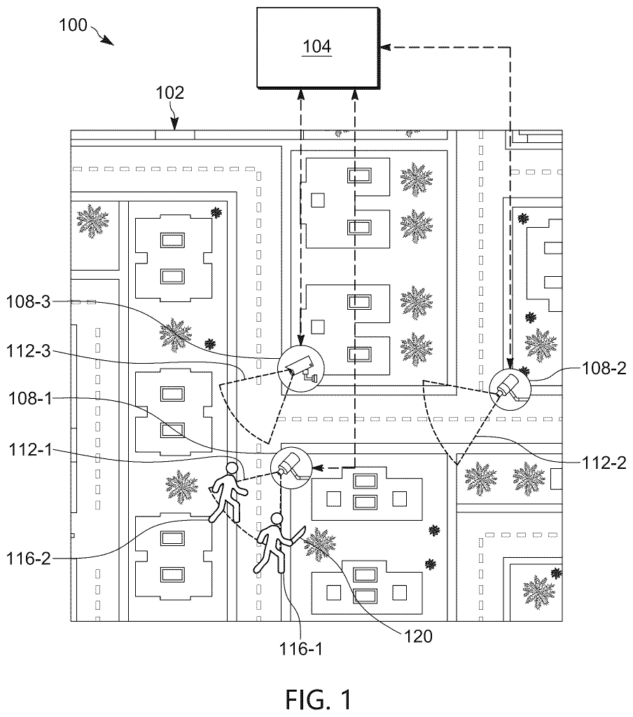

Referring now to the drawings, and in particular FIG. 1, an example system 100 for initiating selective privacy overrides for targeted object recognition is depicted. The system 100 may be deployed to monitor an environment 102, such as a city or other urban or metropolitan area, a localized and/or private environment, such as the grounds or campus of an educational institution, health facility, other institution, or the like. In other examples, the system 100 may also be deployed to monitor a wide variety of other environments.

The system 100 includes a server 104 interconnected with a plurality of video cameras, of which three example video cameras 108-1, 108-2, and 108-3 (referred to herein generically as a video camera 108 and collectively as the video cameras 108; this nomenclature is also used elsewhere herein) are depicted. The video cameras 108 may be any suitable video cameras such as surveillance cameras, and may include components in both public and private infrastructure, such as municipally-implemented traffic systems, privately-owned corporate security or surveillance systems, privately-owned residential and/or individual security or surveillance systems, and the like. The cameras 108 are configured to communicate with the server 104 via one or more wired or wireless connections traversing one or more communications networks, including one or more local-area networks, one or more wide-area networks, such as the Internet, combinations of the above, and the like. Each video camera 108 has a respective field of view (FOV) 112-1, 112-2, and 112-3 encompassing a portion of the environment 102 according to the placement and positioning of the camera 108, the pan, tilt and zoom parameters of the camera 108 and the like.

In operation, the server 104 is configured to obtain video data from at least one of the cameras 108 and monitor the video data for trigger conditions or events (e.g., events which are or may lead to a public safety risk), such as detection of an aggressive, inebriated or otherwise risk-prone individual, the presence of a restricted item or substance, such as a weapon, drugs, or alcohol, combination of factors, and the like. Further, to mitigate privacy concerns with respect to the monitoring and tracking of private citizens not posing a public safety risk, the server 104 may be configured to restrict the analytics applied to the video data to object detection analytics to detect objects, such as the restricted items or substances, or the presence of faces (i.e., without applying recognition analytics to determine the identity associated with individual faces) or the like. For example, the object detection analytics may further include object classification methods which assign a classification label to identify the type or class of the object without identifying the specific unique identity of the individual object. In particular, the object detection analytics excludes biometrics recognition which uniquely identifies individuals based on biometric characteristics. That is, the privacy rights are maintained by inhibiting the general use of object recognition analytics, while still applying object detection analytics to identify and select specific target objects for which to apply a privacy override to apply the object recognition analytics.

When a trigger is detected, the server 104 may initiate selective privacy overrides for targeted object recognition to track and/or facilitate mitigation of the risk event. That is, object recognition analytics may be applied in accordance with the selective privacy override. The object recognition analytics may allow the unique recognition and identification of specific individuals, for example using biometric features, such as facial recognition, gait recognition, recognition of unique physical characteristics, or the like. Accordingly, the object recognition analytics may be defined as biometric recognition for the biometric analytics applied to identify individuals. To further maintain privacy rights of private citizens, the privacy override may further be applicable to time-dependent, spatial locations consistent with a tracking trajectory of a target object. That is, the server 104 may determine a tracking trajectory of the target object and identify the expected spatial locations of the target object, which may vary over time (i.e., with the projected or expected tracking trajectory of the target object over time). These spatial locations may be covered by a portion of the respective FOVs 112 of the cameras 108 and hence the privacy override may be limited to portions of the FOVs 112 corresponding to these spatial locations. Further, since the spatial locations are time-dependent according to the tracking trajectory of the target object, the privacy override may be similarly limited in a time-dependent manner to portions of the FOVs 112 consistent with the tracking trajectory of the target object.

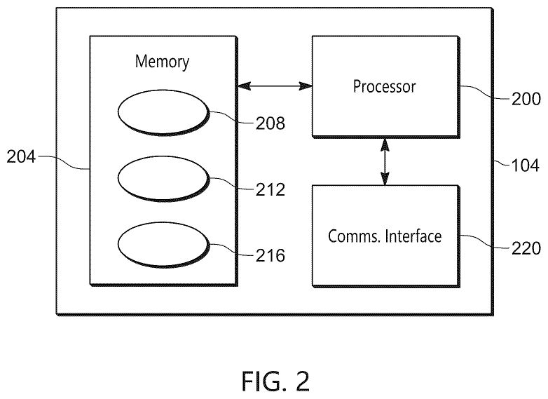

Turning now to FIG. 2, certain internal components of the server 104 are illustrated. The server 104 includes a controller, such as a processor 200, interconnected with a non-transitory computer-readable storage medium, such as a memory 204.

The processor 200 may include one or more logic circuits, processing units, microprocessors, GPUs (Graphics Processing Units), ASICs (application-specific integrated circuits), FPGAs (field-programmable gate arrays) and/or other suitable units capable of executing instructions to carry out the functionality described herein. The memory 204 includes a combination of volatile memory (e.g., Random Access Memory or RAM) and non-volatile memory (e.g., read only memory or ROM, Electrically Erasable Programmable Read Only Memory or EEPROM, flash memory, etc.). The processor 200 and the memory 204 may each comprise one or more integrated circuits.

The memory 204 stores computer-readable instructions for execution by the processor 200. In particular, the memory 204 stores an application 208 which, when executed by the processor 200, configures the processor 200 to perform various functions discussed below in greater detail and related to the selective privacy override operation of the server 104. In particular, the application 208 may include code operable to selectively override privacy protections to perform targeted object recognition. The memory 204 may further store object detection analytics 212 which may be invoked by the application 208 for detecting objects, for example for use in monitoring for events and/or trigger conditions in which a privacy override may be warranted, or for analyzing the video data for use in determining a subset of the objects in the video data for which the privacy override applies, or the like. The memory 204 further stores object recognition analytics 216 which may similarly be invoked by the application 208 for recognizing objects.

Some or all of the object detection analytics 212 and the object recognition analytics 216 may be integrated with the application 208. Some or all of the application 208 may also be implemented as a suite of distinct applications. Those skilled in the art will appreciate that the functionality implemented by the processor 200 via execution of the application 208, the analytics 212 and 216 and the code contained therein may also be implemented by one or more specially designed hardware and firmware components.

The server 104 may further include a communications interface 220 enabling the server 104 to exchange data with other computing devices, such as the video cameras 108. The communications interface 220 is interconnected with the processor 200 and includes suitable hardware (e.g., transmitters, receivers, network interface controllers and the like) allowing the server 104 to communicate with other computing devices. The specific components of the communications interface 220 may be selected based on the type of network or other links that the server 104 is to communicate over. For example, the communications interface 220 may be configured for wired communications, including Ethernet, USB (Universal Serial Bus), twisted pair, coaxial, fiber-optic or similar physical connections, or wireless communications, including one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series standard), a Worldwide Interoperability for Microwave Access (WiMAX) network, for example operating in accordance with an IEEE 802.16 standard, and/or another similar type of wireless network, combinations of the above, and the like.

The server 104 may further include one or more input and/or output devices (not shown). The input devices may include one or more buttons, keypads, touch-sensitive display screens or the like for receiving input from an operator. The output devices may further include one or more display screens, sound generators, vibrators, or the like for providing output or feedback to an operator.

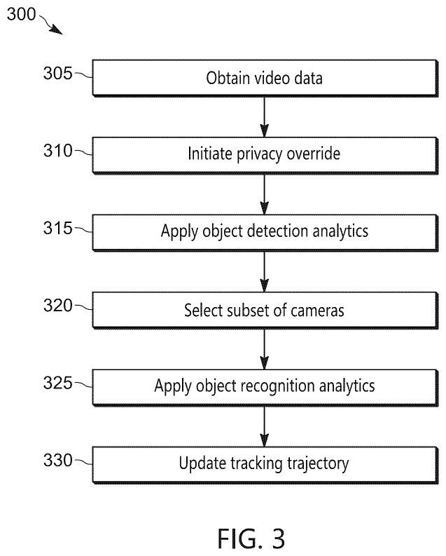

Turning now to FIG. 3, the functionality implemented by the server 104 will be discussed in greater detail. FIG. 3 illustrates a method 300 of implementing selective privacy overrides for targeted object recognition. The method 300 will be discussed in conjunction with its performance in the system 100 and particularly by the server 104, via execution of the application 208. In particular, the method 300 will be described with reference to the components of FIGS. 1 and 2. In other examples, some or all of the method 300 may be performed by other suitable devices or systems. For example, some of the blocks of the method 300 may be performed by the video cameras 108 having sufficient processing capacity (e.g., by a graphics or video processing unit of the video camera 108).

The method 300 is initiated at block 305, where the server 104 obtains video data from at least one of the video cameras 108 having a corresponding field of view 112. For example, the server 104 may obtain video data from video cameras 108 which are part of a public infrastructure, such as police, emergency services, or government-owned closed-circuit television (CCTV) cameras or the like. The server 104 may analyze the video data for certain conditions or event which may initiate a privacy override, for example because the events or conditions are or may lead to a public safety risk.

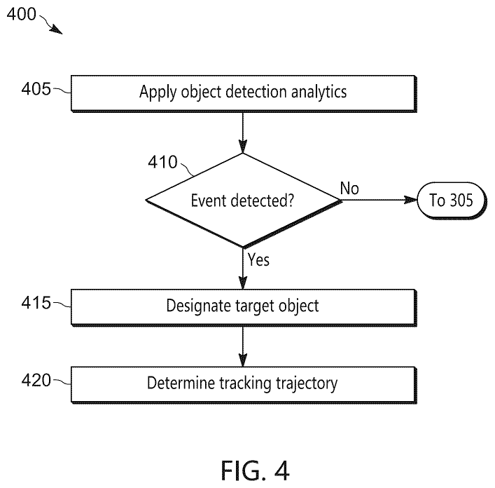

Referring to FIG. 4, an example method 400 of analyzing video data to identify an event which may initiate a privacy override is depicted. In some examples, some or all of the method 400 may be performed by one or more of the video cameras 108 and the results passed to the server 104.

At block 405, the server 104 is configured to apply the object detection analytics 212 to detect a plurality of objects within the FOV 112 represented by the video data. For example, the objects may include faces (and more particularly, the presence of faces), and other objects, including restricted items and/or substances, such as weapons, firearms, explosives, alcohol, drugs, or the like. In particular, the object detection analytics 212 may detect and classify items or substances but may be restricted to detection of the presence of faces or individuals, without analyzing or recognizing the features which uniquely identify a specific individual. In some examples, in addition to detecting the presence of faces or individuals, the object detection analytics 212 may be configured to determine a predicted state of mind or temperament of the detected individuals, for example by analyzing non-identifying facial features, body position and/or movements over a time frame, or the like.

At block 410, the server 104 may be configured to assess the results of the object detection analytics 212 to determine whether an event eligible for initiating a privacy override is detected. In some examples, the detection and classification of certain restricted objects (e.g., a firearm, explosive or other imminent risk or hazard) may be assessed as an event (e.g., constituting a public safety risk) eligible for initiating a privacy override. In other examples, the server 104 may assess an event eligible for initiating a privacy override based on activity of detected object(s) and/or some combination of detected objects, including a predicted state of mind or temperament of individuals, the presence of other individuals (e.g., bystanders) in the vicinity, or the like.

For example, in the example illustrated in FIG. 1, at block 405, the server 104 may classify two objects as two individuals 116-1 and 116-2 and a knife 120. Further, the server 104 may identify the knife 120 as a restricted or classified item. Accordingly, at block 410, the server 104 may make a determination that the combination of the presence of the restricted item (i.e., the knife 120) and multiple individuals 116 (e.g., that there is a potential aggressor and victim and/or potential for one of the individuals to incite an altercation, etc.) constitutes an event for which a privacy override is eligible.

In still further examples, the results of the object detection analytics 212 and/or the raw video data obtained from the video cameras 108 at block 305 may be input into an artificial intelligence and/or machine learning algorithm (e.g., employing one or more neural networks or deep learning algorithms or the like) trained to identify risk events which may be eligible for initiating a privacy override. The artificial intelligence algorithm may return an affirmative or a negative decision as well as a confidence level about the assessment of a risk event. In other examples, other manners of assessing whether an event is eligible for initiating a privacy override, such as applying a statistical analysis based on historically similar event, for example including similar detected objects, environmental factors or other parameters, are also contemplated. For example, while a restricted substance such as alcohol may not be an imminent public safety risk, inebriated individuals may be statistically more likely to commit a crime in the near future, and accordingly, detection of an inebriated individual (e.g., based on movement patterns to predict a level of inebriation) in combination with additional restricted substances may result in the server 104 assessing an event for which a privacy override is eligible.

If the determination at block 410 is negative, that is, no risk or privacy override event is detected, then the server 104 may return to block 305 of the method 300 to obtain further video data from the public CCTV cameras 108 to continue monitoring for potential risk events.

If the determination at block 410 is affirmative, that is, the server 104 identifies an event which may pose a public safety risk and may therefore be eligible for initiating a privacy override, then the server 104 proceeds to block 415. At block 415, in response to identifying the potential risk/privacy override event, the server 104 is configured to designate a target object for the privacy override in accordance with the detected event. For example, the target object may be the individual with whom the restricted object is associated (e.g., based on being in the possession of the individual or the like), or otherwise the individual around whom the event eligible for initiating a privacy override was assessed.

In the example illustrated in FIG. 1, the server 104 may determine that the knife 120 is associated with the detected individual 116-1, for example as a sub-object of the individual 116-1. For example, the individual 116-1 may be identified within a first bounding box, and the server 104 may define a second bounding box within the first bounding box, the second bounding box defining the knife. Accordingly, the individual 116-1 may be designated by the server 104 as the target object at least for as long as the individual 116-1 continues to be classified as a person carrying a knife.

At block 420, after designating the target object, the server 104 may additionally be configured to determine a tracking trajectory for the target object. In particular, when the target object is an individual, the individual may move about the environment 102. Accordingly, to better manage public safety risk and facilitate deployment of resources (e.g., police, mental health or other medical professionals, other responder programs, etc.) to manage and de-escalate the event, the server 104 may track and predict the trajectory of the movement of the target object. In some examples, the tracking trajectory may be determined without applying the object recognition analytics 216. For example, the detected objects may be determined to be the same object for which a tracking trajectory may be estimated based on the type of object (e.g., vehicle, person, etc.), the general size and shape of the object as detected in successive frames or frame periods, the distance between the positions of detected objects in successive frames or frame periods, and the like.

For example, the server 104 may predict a tracking trajectory for an upcoming period of time based on a current position, a speed, acceleration, and direction of the movement of the target object over a previous predefined time period (e.g., 1 second, 5 seconds, 10 seconds, 30 seconds, etc.). The server 104 may use the movement parameters of the target object to predict the position of the target object within an upcoming period of time, for example, separated based on predefined time intervals (e.g., to predict the position of the target object over the next 5 seconds, with predictions separated into 1 second intervals).

The server 104 may further assess potential paths for the target object (e.g., streets, alleyways, etc.) as well as whether such paths are accessible for the target object (e.g., if the target individual is in a car, on a bicycle, or the like, then certain pathways may be inaccessible). In some examples, the server 104 may apply one or more artificial intelligence and/or machine learning algorithms to the video data of the target object over the previous predefined time period to assess the tracking trajectory of the target object. The tracking trajectory may extend for a predefined amount of time into the future, and in some examples, may include more than one potential path, and or an expanding potential trajectory (e.g., based on minor to major deviations to the movement pattern of the target object) over time.

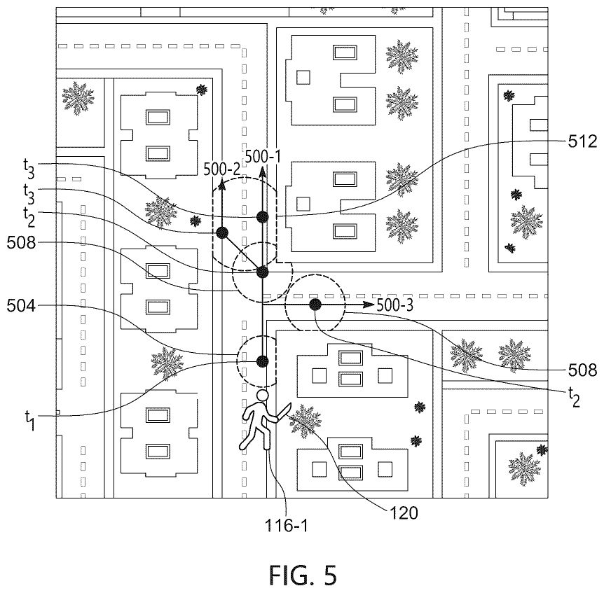

For example, referring to FIG. 5, a schematic diagram illustrates three predicted tracking trajectories 500-1, 500-2 and 500-3. At a first time t₁ (which may represent a particular instant in time, or a time interval, for example based on the intervals over which the tracking trajectory is predicted), each of the tracking trajectories 500 may roughly align, as the target object 116-1 is expected to continue moving down the street. Accordingly, the server 104 may identify a region 504 within a first radius of the tracking trajectories 500 as the spatial location consistent with the tracking trajectory at the time t₁.

At a second time t₂, the first and second tracking trajectories 500-1 and 500-2 may continue to predict the target object 116-1 moving down the street. The third tracking trajectory 500-3 may diverge based on a possibility that the target object 116-1 may turn the corner down a second street. Accordingly, the server 104 may identify multiple regions 508 within a second radius of the tracking trajectories 500 as the spatial locations consistent with the tracking trajectory at the time t₂. Since the consistency of movement of the target object may vary more over time, the second radius defining the regions 508 may be larger than the first radius defining the region 504. In some examples, the server 104 may further restrict the regions 508 based on the features of the environment 102, such as houses or other buildings restricting the possible tracking trajectories 500.

At a third time t₃, the first and second tracking trajectories 500-1 and 500-2 may also separate, for example simply based on variability of movement of the target object 116-1 over time, or the like. This may be reflected in the region 512 defined based on a third radius, larger than the first and second radii.

Returning now to FIG. 3, in response to detecting an event which may initiate a privacy override, for example via execution of the method 400, the server 104 proceeds to block 310. At block 310, the server 104 is configured to initiate a privacy override. In particular, the server 104 may define parameters for the privacy override, including a time duration (e.g., as defined based on a specified start time and end time, for example relative to the detected triggering event) and time-dependent spatial locations. In particular, the spatial locations for which the privacy override are consistent with the tracking trajectory of the target object. Accordingly, since the tracking trajectory of the target object may vary over time (e.g., including within the FOV 112 of the video camera 108 from which the video data is obtained), the spatial locations within the FOV 112 may also vary over the applicable time duration of the privacy override. Further, the spatial locations may correspond to time-dependent portions of the FOV 112 of the camera, such that the privacy override is applicable to only a portion of the FOV 112 corresponding to the spatial location, which in turn is consistent with the tracking trajectory of the target object. The portions of the FOV 112 for which the privacy override is applicable may similarly vary over the applicable time duration of the privacy override based on the tracking trajectory of the target object over said time duration.

In some examples, the spatial locations consistent with the tracking trajectory may be contained in the FOV 112 of more than one video camera 108 or in a different video camera 108 than the video camera 108 from which the event and target object were originally identified. In such examples, the server 104 may extend the privacy override to be applicable to such video cameras 108. Thus, in some examples, the initiation of the privacy override at block 310 may be in response to detection that the tracking trajectory extends within an adjacent field of view 112 of an adjacent video camera 108, for example at a subsequent iteration of the method 300 after a potential risk event and a target object have already been identified.

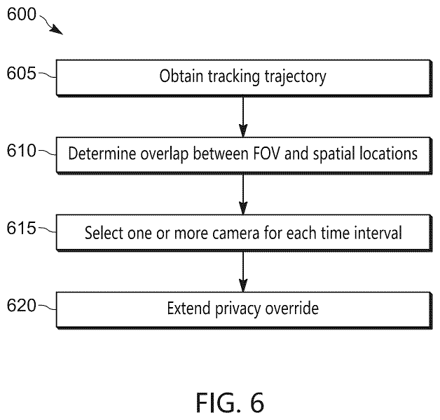

For example, referring to FIG. 6, an example method 600 of extending a privacy override based on the tracking trajectory is depicted.

At block 605, the server 104 obtains the determined tracking trajectory and determines the video cameras 108 within the vicinity (e.g., within a threshold distance) of the tracking trajectory.

At block 610, the server 104 determines an overlap between the FOV 112 of each of the video cameras 108 and the tracking trajectory or more particular, the time-dependent spatial locations consistent with the tracking trajectory for each time or time period (e.g., times t₁, t₂, and t₃ and/or time periods including times t₁, t₂, and t₃).

At block 615, the server 104 is configured to select one or more cameras 108 having a FOV 112 which covers at least a portion of the time-dependent spatial locations for each time or time interval for which the tracking trajectory is tracked.

At block 620, the server 104 is configured to extend the privacy override to the selected subset of video cameras 108. In particular, since the selection of the one or more cameras at block 615 may be based on the time-dependent spatial locations, the extension of the privacy override may similarly be time-dependent and based on the camera 108 corresponding to the time-dependent spatial locations.

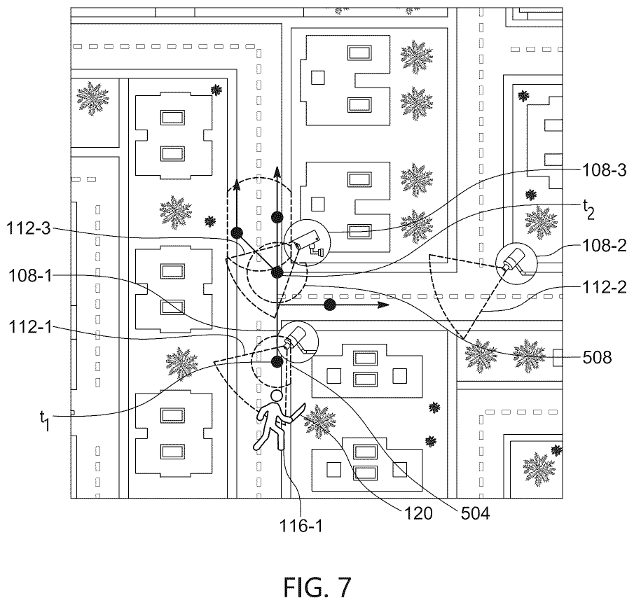

For example, referring to FIG. 7, for time or time interval t₁, the server 104 determines that the FOV 112-1 of the video camera 108-1 overlaps with the region 504 (i.e., the spatial location) consistent with the tracking trajectories 500. Accordingly, the server 104 may select the video camera 108-1 as the relevant camera at block 615 for the time or time interval t₁. The server 104 may then extend the privacy override to the video camera 108-1 for the time interval t₁ based on the time-dependent spatial location or region 504.

For time or time interval t₂, the server 104 determines that the FOV 112-3 of the video camera 108-3 overlaps with the region 508 (i.e., the spatial location) consistent with the tracking trajectories 500-1 and 500-2. Accordingly, the server 104 may select the video camera 108-2 as the relevant camera at block 615 for the time interval t₂. The server 104 may then extend the privacy override to the video camera 108-3 for the time interval t₂ based on the time-dependent spatial location or region 508.

In other examples, the spatial location may be covered by more than one FOV 112 of different cameras 108. When the tracking trajectory extends within the FOV 112 of an adjacent video camera 108, the server 104 may select, at block 615, all the video cameras 108 whose FOVs 112 contain the tracking trajectory. In other examples, the server 104 may select the video cameras 108 whose FOVs 112 contain at least a threshold portion of the tracking trajectory. In still further examples, the server 104 may select only one video camera 108 for extension of the privacy override for a given time. For example, the server 104 may select the video camera 108 for which the spatial location consistent with the tracking trajectory occupies a largest portion of the FOV 112, based on a resolution of the camera 108, based on accessibility of the video data from the video camera 108 (e.g., if the video camera 108 is part of a public infrastructure or is privately owned), a combination or weighted combination of the above and other factors, or the like.

Additionally at block 620, when defining the extension of the privacy override, the server 104 may restrict the portion of the FOV 112 to which the privacy override is applicable. In particular, the server 104 may obtain pan, tilt, zoom, and other location and positioning parameters of the cameras 108 to identify a portion of the FOV 112 which covers the time-dependent spatial location. For example, when consecutive time intervals have corresponding spatial locations covered by the same video camera 108, the portion of the FOV 112 to which may change between the time intervals based on the spatial location consistent with the tracking trajectory. Thus, the privacy override may be applicable to a first portion of a given FOV 112 during a first time interval (i.e., covering the spatial location over said first time interval), and to a second portion of the given FOV 112 during a second time interval (i.e., covering the spatial location over said second time interval).

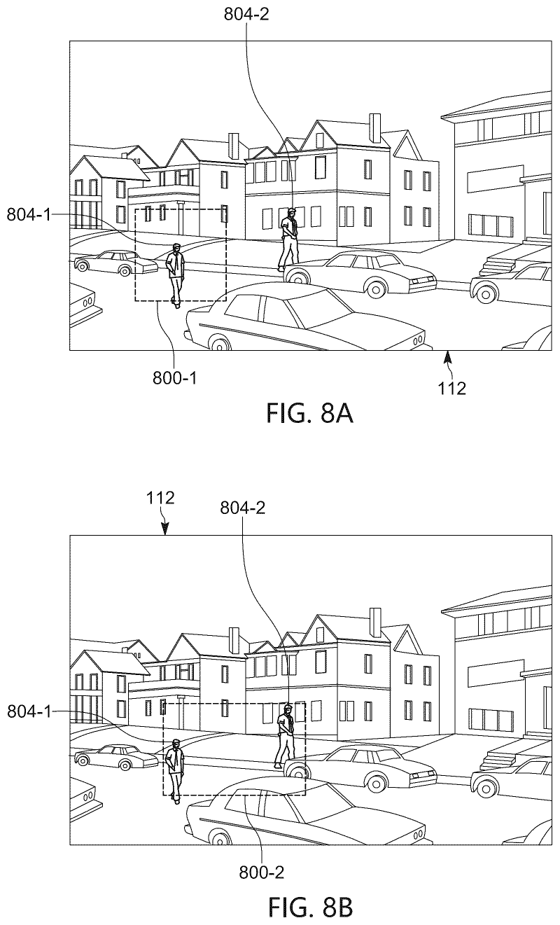

For example, referring to FIG. 8A, an FOV 112 is depicted, with a portion 800-1 to which the privacy override is applicable at a first time interval. Referring to FIG. 8B, within the same FOV 112, the privacy override may be extended to be applicable to a different portion 800-2 for a second time interval.

In some examples, permission for the defined privacy override may be requested from another computing device and/or server operated by a police department, judge, or other authority. For example, if the detected event is identified with below a threshold confidence level by an artificial intelligence algorithm or statistical modelling method, the server 104 (or an independent permissions server) may identify that the privacy override requires approval prior to proceeding. When the event is detected with above the threshold confidence level, the server 104 (or the independent permissions server) may automatically approve the privacy override. Other factors, such as the type of event identified, a classification of the restricted item or substance, or the like, may also contribute to the determination as to whether approval of the privacy override is automatically granted. For example, when the adjacent video camera 108 to which the privacy override is to be extended is privately owned, additional permissions or authentication may be required to obtain the video data for which to apply the selective privacy override.

Returning again to FIG. 3, upon approval of the privacy override, at block 315, the server 104 may be configured to further apply the object detection analytics to detect a plurality of objects in the field of view 112 of the video camera 108 from which the video data was obtained. In particular, at block 315, the server 104 may specifically perform face detections to detect a plurality of faces, without applying biometric recognition analytics, from which to select a subset for subsequently applying the object recognition analytics 216.

Accordingly, at block 320, the server 104 is configured to select a subset of the detected objects (or faces) which comply with the privacy override parameters. Specifically, the server 104 may select a subset of the detected faces which are located at time-dependent, spatial locations consistent with the tracking trajectory of the target object within the FOV 112. Thus, if multiple faces are detected, the server 104 may select the subset to limit the application of the object recognition analytics 216 to the faces which are likely to correspond to the target object (i.e., based on the predicted spatial location of the target object).

At block 325, the server 104 is configured to apply the object recognition analytics 216 to the subset of faces selected at block 320. That is, the server 104 may perform facial recognition or other recognition algorithms to assess facial or other features to uniquely identify the target person. In other words, the server 104 may apply biometric recognition at block 325 to recognize specific biometric features used to identify the target person. For example, the server 104 may additionally or alternatively apply human gait recognition, recognition based on unique physical identifiers, or the like. In particular, the server 104 may apply facial recognition and may compare the identified individuals (i.e., from the subset of faces selected at block 320) to previously identified individuals, for example from previous iterations of the method 300, or to a database of tracked or known individuals, or the like.

Thus, referring again to FIG. 8A, the server 104 may detect two faces 804-1 and 804-2 within the frame of view 112. The server 104 may additionally identify that only the face 804-1 complies with the privacy override parameters - that is, that only the face 804-1 is in a spatial location consistent with the tracking trajectory of the target object. Accordingly, at block 325, the server 104 may apply the object recognition analytics 216 to the face 804-1 only, and not the face 804-2. In particular, the initial detection operation and matching with spatial locations consistent with a tracking trajectory may improve the computational efficiency of the server 104, since the object recognition analytics 216 may be more computationally intensive than the object detection analytics. Accordingly, the object recognition analytics 216 may be run on a subset of the detected faces, according to the time-dependent spatial locations consistent with the tracking trajectory of the target object.

Referring to FIG. 8B, in a subsequent time interval, the server 104 may detect the two faces 804-1 and 804-2 within the frame of view 112. Since the tracking trajectory may be potentially wider based on variability in movement of the target object, the portion 800-2 covering the spatial locations consistent with the tracking trajectory may be wider. Accordingly, the server 104 may apply the object recognition analytics 216 to both the faces 804-1 and 804-2.

At block 330, if one or more of the individuals identified at block 325 corresponds to the tracked target individual and/or other subjects of interest, then the server 104 may identify metadata of the object recognition analytics (e.g., datetime, specific geographic location, etc.) and store and/or forward the metadata to another server (e.g., a tracking server or the like), and one or more adjacent video cameras 108. Specifically, the server 104, the tracking server or other server and/or the one or more adjacent video cameras 108 may use the metadata to update the tracking trajectory of the target individual. For example, having identified the individual 116, the tracking trajectory may be more precisely computed according to the previously known location of the individual 116, rather than inferring the movement of objects based on expected movement and location. The server 104 may then extend the privacy override, for example via performance of the method 600, based on the updated tracking trajectory of the target individual.

Additionally, in some examples, when the tracked target individual is not recognized or detected after application of the object recognition analytics 216, the server 104 may revoke the privacy override. Alternately, if the tracked targeted individual is recognized in a different field of view (e.g., if the privacy override was granted to multiple video cameras in anticipation of multiple possible tracking trajectories) which does not overlap with the field of view of the first video camera, then the privacy override may be revoked from the first video camera. In some examples, the server 104 may allow a buffer of time for which the tracked target individual is not recognized (e.g., to allow for errors in the object recognition analytics 216 or the like) prior to revoking the privacy override.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot monitor and detect video data for potential risk events in particular, in such excessive quantities as is available from public and private surveillance and monitoring, as well as selectively initiating a privacy override to apply object recognition analytics targeted at time-dependent, spatial locations consistent with a tracking trajectory of the target object, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more”unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method comprising:
obtaining video data captured from a video camera having a field of view;
initiating a privacy override for the video data for a time duration, the privacy override applicable to time-dependent, spatial locations consistent with a tracking trajectory of a target object;
applying object detection analytics to detect a plurality of objects in the field of view of the video camera; and
applying the privacy override to enable object recognition analytics to be applied to the video data over the time duration of the privacy override, at the locations of the privacy override, to selectively identify the target object from the plurality of objects and inhibiting the object recognition analytics for a remainder of the plurality of objects.

2. The method of claim 1, wherein the privacy override is initiated in response to detection of an event in the video data.

3. The method of claim 2, wherein the detection of the event in the video data is performed by an artificial intelligence algorithm or statistical modelling.

4. The method of claim 2, further comprising:
determining a confidence level of detection of the event;
when the confidence level exceeds a threshold confidence level, automatically granting the privacy override; and
when the confidence level is below the threshold confidence level, requesting permission for the privacy override and applying the privacy override when the permission is granted.

5. The method of claim 1, wherein the detection analytics comprise detection of one or more faces in the field of view and wherein the recognition analytics comprise facial recognition of the target object to identify the target object from the one or more faces.

6. The method of claim 1, wherein the privacy override is applicable to corresponding portions of the field of view of the video camera corresponding to the time-dependent spatial locations.

7. The method of claim 1, further comprising forwarding metadata of the recognition analytics to at least one of a server and one or more adjacent video cameras to update the tracking trajectory.

8. The method of claim 7, further comprising:
updating the tracking trajectory of the target object based on the metadata of the recognition analytics; and
updating the privacy override according to the updated tracking trajectory.

9. The method of claim 8, further comprising:
determining that the updated tracking trajectory extends within an adjacent field of view of an adjacent video camera; and
extending the privacy override to the adjacent video camera.

10. The method of claim 1, further comprising:
when the target object is no longer detected after the time duration, revoking the privacy override.

11. A computing device comprising:
a memory storing executable code;
a communications interface;
a processor interconnected with the memory and the communications interface, the processor to execute the code, the code operable to cause the processor to:
obtain video data captured from a video camera having a field of view;
initiate a privacy override for the video data for a time duration, the privacy override applicable to time-dependent, spatial locations consistent with a tracking trajectory of a target object;
apply object detection analytics to detect a plurality of objects in the field of view of the video camera; and
apply the privacy override to enable object recognition analytics to be applied to the video data over the time duration of the privacy override, at the locations of the privacy override, to selectively identify the target object from the plurality of objects and inhibit the object recognition analytics for a remainder of the plurality of objects.

12. The computing device of claim 11, wherein the privacy override is initiated in response to detection of an event in the video data.

13. The computing device of claim 12, wherein the detection of the event in the video data is performed by an artificial intelligence algorithm or statistical modelling method.

14. The computing device of claim 12, wherein the code is further operable to cause the processor to:
determine a confidence level of detection of the event;
when the confidence level exceeds a threshold confidence level, automatically grant the privacy override; and
when the confidence level is below the threshold confidence level, request permission for the privacy override and applying the privacy override when the permission is granted.

15. The computing device of claim 11, wherein the detection analytics comprise detection of one or more faces in the field of view and wherein the recognition analytics comprise facial recognition of the target object to identify the target object from the one or more faces.

16. The computing device of claim 11, wherein the privacy override is applicable to corresponding portions of the field of view of the video camera corresponding to the time-dependent spatial locations.

17. The computing device of claim 11, the code further operable to cause the processor to: forward metadata of the recognition analytics to at least one of a server and one or more adjacent video cameras to update the tracking trajectory.

18. The computing device of claim 17, the code further operable to cause the processor to:
update the tracking trajectory of the target object based on the metadata of the recognition analytics; and
update the privacy override according to the updated tracking trajectory.

19. The computing device of claim 18, the code further operable to cause the processor to:
determine that the updated tracking trajectory extends within an adjacent field of view of an adjacent video camera; and
extend the privacy override to the adjacent video camera.

20. The computing device of claim 11, the code further operable to cause the processor to:
when the target object is no longer detected after the time duration, revoke the privacy override.
